(19) United States
(12) Patent Application Publication
(10) Pub. No.: US 2014/0247695 A1
(43) Pub. Date: Sep. 4, 2014

(54) METHOD FOR ROBUST AND FAST PRESENCE DETECTION WITH A SENSOR

(71) Applicants: Jurgen Mario Vangeel, Beerse (BE); Tony Petrus Van Endert, Lommel (BE); Jingeng Huang, Eindhoven (NL)

(72) Inventors: Jurgen Mario Vangeel, Beerse (BE); Tony Petrus Van Endert, Lommel (BE); Jingeng Huang, Eindhoven (NL)

(73) Assignee: KONINKLIJKE PHILIPS N.V., EINDHOVEN (NL)

(21) Appl. No.: 14/125,121

(22) PCT Filed: Jun. 15, 2012
(86) PCT No.: PCT/IB2012/053024

§ 371 Date: May 21, 2014

Related U.S. Application Data
(60) Provisional application No. 61/499,414, filed on Jun. 21, 2011.

(30) Foreign Application Priority Data
Jun. 15, 2011 (GB) 1110114.4

(51) Int. Cl. G01S 15/04

(52) U.S. Cl. CPC G01S 15/04
USPC 367/93

(57) ABSTRACT

A method is presented for detecting the presence of objects. The method differentiates animate objects within a presence detector detection area from inanimate objects within the detection area. Moving objects passing nearby the detection area are further distinguished from objects entering or leaving the detection area. The method distinguishes inanimate objects from dormant animate objects within the detection areas.

### TECHNICAL FIELD

The present invention is directed generally to sensor technology. More particularly, various inventive methods disclosed herein relate to presence detectors.

### BACKGROUND

Presence detectors may employ a variety of technologies. For example, pneumatic tubes or hoses may be placed across a roadway to detect the pressure of a vehicle as its tires roll over the tubes or hoses. Such detectors operate through physical contact with the object being detected. In another example, an optical light beam emitter and sensor system may detect the presence of an object when the object interrupts a projected light beam. In addition, in-ground inductance loops may detect a vehicle in close proximity by detecting a change in magnetic inductance. Other examples of presence detectors include video detectors and audio detectors.

Time-of-flight presence detectors generally include one or more sensors, for example, ultrasound sensors. Time-of-flight presence sensors are used in various applications to detect the presence of objects within a specified field of detection. Unlike pneumatic tubes, the ultrasound sensors do not require physical contact with the item being detected. Unlike inductance loops, ultrasound sensors can sense object regardless of the magnetic properties of the object. Further, unlike a simple optical beam interruption system, time-of-flight detectors can determine the distance from the detector to the object.

Ultrasound sensors are typically oriented either horizontally or vertically. For example, a horizontally oriented ultrasound sensor, also called a front measuring sensor, may detect objects entering a detection area in front of the sensor. In contrast, a top measurement sensor is an example of a vertically oriented sensor. A top measurement sensor may be mounted on the ceiling of a room, or to an overhead fixture, and detect objects entering a detection area below the sensor.

An ultrasound sensor generally emits a burst or pulse of energy in the ultrasound frequency band, typically in the 20 KHz to 200 MHz range. When the pulse encounters a physical surface, a portion of the energy of the pulse is reflected back to the sensor. The reflection is also known as an echo. The sensor measures the time elapsed between the pulse transmission and the reception of the pulse reflection, called the time-of-flight measurement. The distance between the object from and sensor may be calculated based upon the measured time-of-flight.

Ultrasound presence detectors may use a reference threshold corresponding to a maximum ultrasonic echo response time as the operable detection distance range. The presence of an object within the range is detected when a reflection is measured with an ultrasonic echo response time shorter than the reference threshold. When used to detect the presence of human beings, problems may occur when a fixed object is imported within the detection range, as it may be difficult to distinguish between detection of human beings and detection of fixed objects. For example, under a first problem scenario, if a person carries a large object, such as a cardboard box, into the detection area, such as a room, and the person places the box within the detection area and then departs, the sensor will continue to sense the box and may erroneously continue to report the presence of a person in the room. It is possible to calibrate the sensor to memorize ultrasound echo responses that correspond with fixed objects in the room. However, such calibration is typically performed only during installation and customization.

Prior presence detectors may not adequately define the boundaries of the detection area. A second problem scenario is distinguishing an object entering a detection area from an object merely passing close by the detection area but not actually entering the detection area. A simple binary detection system may interpret any detected motion as an object being present and will interpret a lack of motion as no object being present. Therefore, an object merely passing nearby the sensor area may falsely trigger the detector.

Prior presence detectors may not adequately distinguish between large magnitude and small magnitude motions. A third scenario where prior presence detectors may be inadequate may occur when an animate object enters the sensor detection area but becomes temporarily dormant. For example, a person may enter a room monitored by a presence detector, sit down, and remain still for several minutes. This may cause the motion detector to switch to a no-object-detected state based upon lack of detected movement. For instance, a person quietly reading in a room with a prior presence detecting light switch may find himself in the dark after a period of time when the detector detects little or no motion. In particular, presence detectors that compare the magnitude of a detected motion to an average detected motion may fail to distinguish a dormant animate object from an inanimate object.

More sophisticated presence detectors have been developed using complex statistical analysis collected within the detection area over time. While such detectors may provide an accurate analysis of motion within the detection area, their reliance on relatively long term data collection is not suitable for applications that rely upon fast recognition of changes within the detection area.

Thus, there is a need in the industry for fast, robust, and dynamic detection of animate objects within a sensor detection area without recalibrating the sensor when inanimate objects are introduced or removed. Further, there is a need to accurately and quickly distinguish between inanimate objects and animate objects making small or infrequent movements. Finally, there is a need to distinguish objects within a detection area from objects leaving or passing nearby the detection area.

### SUMMARY

The present disclosure is directed to inventive methods for quickly and accurately differentiating animate objects within a sensor detection area from inanimate objects that are moved into the sensor detection area. The methods distinguish objects passing nearby the detection area from objects entering or leaving the detection area. The methods further distinguish inanimate objects from dormant animate objects within the sensor detection area. For example, the sensor may be a top measurement or front measurement ultrasound sensor configured to detect the presence of a person in a room.

Generally, in one aspect, a method detects the presence of an object within a detection area of a sensor. The sensor is configured to transmit a signal and receive a signal reflection. The detection area includes a first zone and a second zone. The first zone includes an area within a first distance from the sensor, and the second zone includes an area beyond the first zone and within a second distance from the sensor, where the second distance is greater than the first distance. The method includes the steps of detecting an object with the sensor and determining if the object is in the detection area. If the object is within the detection area, a step includes characterizing the object as either an animate object or an inanimate object. If the object is within the detection area and is characterized as inanimate, a step includes declaring the object not present. If the object is within the detection area and is characterized as animate, a step includes declaring the object present.

Under a first embodiment of the first aspect, a step may include measuring a time-of-flight between the signal transmission and the signal reflection. Under a second embodiment, the step of characterizing the object further includes detecting if the object is moving. If the object is moving, the step includes characterizing the object as animate, or if the object is not moving, measuring an inactivity time span, and if the inactivity time span exceeds an inactivity threshold, characterizing the object as inanimate. In a second embodiment, determining if the object is in the detection area further includes the step of calculating an object distance between the object and the sensor. If the object distance is less than the first distance, a step includes determining the object is detected in the first zone. If the object distance is less than the second distance and greater than the first distance, a step includes determining the object is detected in the second zone. In a third embodiment, if the object is detected in the first zone, a step includes clearing an object leaving flag, and if the object is not detected in the first zone, determining it the object is leaving the detection area. If the object leaving flag is clear, determining if the object is leaving the detection area further includes the step of measuring an object level of movement. If the object level of movement is greater than a movement threshold, a step includes setting the object leaving flag. If the object is not active and not in the second zone, a step includes setting the object leaving flag. If the object leaving flag is set and the object is not detected in the second zone, determining if the object is leaving the detection area further includes declaring the object not present. In a fourth embodiment of the first aspect, detecting whether the object is moving further includes the steps of calculating an average time-of-flight, and calculating a variance between the time-of flight and the average time of flight.

Generally, in a second aspect, a method for detecting objects within a detection area of a time-of-flight sensor includes the steps of monitoring time-of-flight sensor measurements, calculating an average time-of-flight, calculating a variance from the average time-of-flight, detecting an object moving within the detection area, and determining if the object has stopped moving while remaining within the detection area.

In a first embodiment of the second aspect, the time-of-flight sensor includes an ultrasound sensor. In a second embodiment, a step includes determining if the object has left the detection area. If the object is moving within the detection area, a step includes indicating that the object is present. If the object has stopped moving while remaining within the detection area, a step includes indicating that no object is present. If the object has left the detection area, a step includes indicating that no object is present. In a third embodiment of the second aspect, the step determining if the object has stopped moving while remaining within the detection area further includes the step of determining if the variance in time-of-flight measurements has remained below a variance threshold for a predetermined time.

Generally, in a third aspect, a computer readable medium has stored thereon instructions that, when executed, direct a system comprising a processor and an ultrasound sensor to detect the presence of animate objects within a detection area. The detection area includes a first zone and a second zone, where the first zone includes an area within a first distance from the sensor and the second zone comprises an area beyond the first one and within a second distance from the sensor. The instructions include the steps of transmitting a transmitted signal by the ultrasound sensor, receiving a reflected signal, wherein the reflected signal comprises a portion of the transmitted signal reflected back from an object, measuring a time-of-flight between the transmitted signal and the reflected signal, calculating an average time-of-flight, and calculating a variance between the time-of flight and the average time of flight.

Additional steps in the instructions stored on the computer readable medium include determining if the object is in the detection area. If the object is within the detection area, a step includes characterizing the object as one of a group consisting of animate objects, and inanimate objects. If the object is within the detection area and is characterized as inanimate, a step includes declaring the object not present. If the object is within the detection area and is characterized as animate, a step includes declaring the object present.

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited, to conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, as controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “animate object” as used herein refers to an object capable of controlled motion without the assistance of an external force. For example, a person or an animal may be an animate object. In contrast, as used herein, the term “inanimate object” is an object that is not capable of movement without the assistance of an external force. Examples of an inanimate object may include a cardboard box or a chair. Of course, inanimate objects may be moved by animate objects. An animate object that is not moving is herein distinguished from an inanimate object by referring to the non-moving animate object as dormant.

The term “detection area” as used herein refers to a space in the vicinity of a presence sensor wherein the presence sensor may sense the presence of an object. The detection area may be physically bounded, for example, by a floor or a wall, or the detection area may not be physically bounded, but instead defined as a range of distances from the presence sensor. The detection area may be bounded according to the maximum detection range limitation of the presence sensor, or may be an area defined within the maximum detection range of the presence sensor.

The term “presence sensor” as used herein refers to a device capable of sensing an object. Examples of presence sensors that may be employed in various implementations of the present disclosure include, but are not limited to light beam sensors, pressure sensors, sonic sensors, video sensors, motion sensors, and time-of-flight sensors. A presence sensor may provide Boolean results, for example, whether an object is sensed or not sensed, or may provide more detailed information, for example, the distance of the object from the presence sensor, or the amount of force exerted upon the sensor by the object. The term “presence detector” as used herein refers to a device or system including one or more presence sensors, generally including a processor for manipulating data provided by the presence sensor. A presence detector may include logical circuitry for making a determination whether an object is present or whether an object is not present based upon the manipulated presence sensor data.

The term “flag” as used herein refers to a means for maintaining a logical Boolean state. For example, a flag may refer to a binary semaphore or Boolean variable. Examples of Boolean states include, but are not limited to, on/off, true/false, etc. The terms “set” and “clear” in reference to a flag refer to changing the state of the flag. Therefore, setting a flag typically indicates changing the a state of a flag to “on,” or “true,” while clearing a flag typically indicates changing the state of the flag to “off,” or “false.” For example, a flag may be used to determine a course of action in a logical flowchart, such as at a decision branch. However, persons having ordinary skill in the art will recognize additional mechanisms capable of serving as flags.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1A illustrates a first embodiment of a lighting fixture with a front detecting Presence detector from a side view.

FIG. 1B is a schematic diagram of a lighting fixture and front sensor detection area from a top view.

FIG. 2 illustrates a scenario where a presence detector may distinguish an animate object from an inanimate object.

FIG. 3 is a first logical flowchart of an exemplary embodiment of a method for detecting the presence of an object with a sensor.

FIG. 4 is a second logical flowchart of an exemplary embodiment of a method for detecting the presence of an object with a sensor.

FIG. 5 is a schematic diagram of a computer system for detecting the presence of an object with a sensor.

### DETAILED DESCRIPTION

In view of the foregoing, various embodiments and implementations of the present invention are directed to a method for fast and robust presence detection.

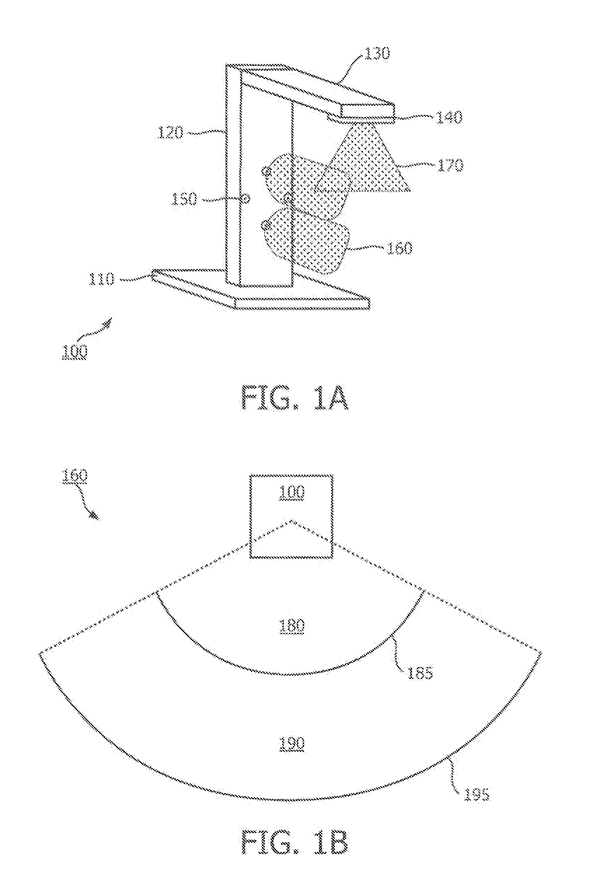

Referring to FIG. 1A, in one embodiment, a lighting fixture 100 includes a presence detector configured to distinguish animate objects from inanimate objects. The lighting fixture 100 includes a base 110, a column 120, and an overhead support 130, where the overhead support includes a lighting unit 140. The lighting fixture includes four ultrasound presence sensors 150 located within the column 120. Each ultrasound presence sensor 150 is associated with a front detection area 160, where the ultrasound presence sensor 150 is capable of detecting an object within the detection area 160. The presence detector in the lighting fixture 100 may be configured to turn the lighting unit 140 on or off depending upon whether one or more ultrasound sensors 150 sense the presence of an animate object within the corresponding detection area 160. For example, if the lighting unit 140 is off and a person enters the detection area 160 of one or more ultrasound presence sensors 150, the lighting fixture 100 turns on, causing the lighting unit 140 to illuminate, producing visible light 170. Of course, the detection area 160 and the visible light 170 will generally extend further than as depicted in FIG. 1A. Also, while FIG. 1A depicts a presence sensor configured as a front sensor, there is no objection to embodiments including presence sensors in other orientations, for example, a top sensor.

FIG. 1B is a schematic diagram of the lighting fixture 100 from a top view, indicating the front detection area 160 projecting outward from the lighting fixture 100. While the detection area is depicted in FIG. 1B as covering an area defined by an arc, there is no objection to a detection area having other shapes, for example, a circle or semicircle. A second threshold distance 195 bounds the outer edge of the detection area 160, and a first threshold distance 185 defines a boundary between a first zone 180 and a second zone 190 within the detection area 160. While the ultrasound sensors 150 (FIG. 1A) may be able to sense objects beyond the detection area 160, the presence detector may be configured to disregard objects beyond the detection area 160.

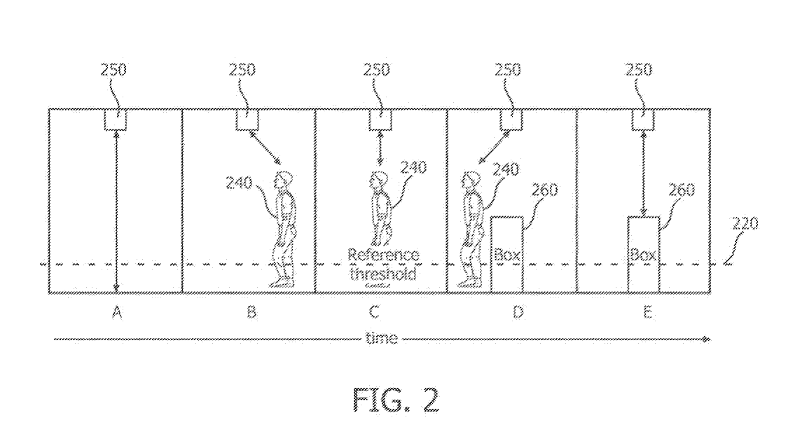

FIG. 2 depicts a five snapshots in time under a second embodiment of a presence detector 250 positioned over a detection area. The presence detector 250 includes a top sensing sensor, for example, an ultrasound sensor, positioned above a detection area, where the presence detector 250 is configured to detect objects above a reference threshold height 220. In frame A, the presence detector 250 does not detect any objects within the detection area. In frame B, a person 240 enters the detection area carrying a box (not shown). In frame C, the person 240 passes directly beneath the presence detector 250, and places the box (not shown) on the ground beneath the presence detector 250. In frame D, the person 240 begins to depart the detection area, leaving the box 260 in the detection area. In frame E the person 240 has departed the detection area, so that the presence detector 250 may detects the box 260 as the closest object to the presence detector 250.

As described previously, prior presence detectors may erroneously report the presence of an object or the lack of presence of an object within a detection area after an inanimate object has been introduced or removed from the detection area. Since the box 260 is an inanimate object, it is desirable for the presence detector 250 to distinguish between an inanimate object, such as the box 260, and an animate object, such as the person 240 in presence sensing applications. More generally, Applicants have recognized and appreciated that it would be beneficial for presence detectors to adapt to the introduction or removal of one or more inanimate objects within the detection area.

Objects detected in the detection area may be active animate objects, dormant animate objects, and inanimate objects. An inanimate object being moved by an animate object is classified as an animate object, although it may later be re-classified as an inanimate object. For example, the person 240 carrying the box 260 may be initially characterized as an animate object. After the person 240 paces the box 260 within the detection area and departs, the presence detector 250 will detect no movement. It would be advantageous, therefore, to eventually change the status of the box as being an inanimate object, thereby indicating no object is present. Similarly, it would be advantageous to distinguish between an inanimate object and an animate object in a dormant or inactive state. It would further be advantageous to distinguish objects entering a detection area from objects leaving the detection area, or objects passing nearby the detection area without actually entering the detection area. Finally, it would be advantageous for such detection to be performed quickly, while minimizing erroneous characterizations. Embodiments of methods addressing these and related scenarios are presented hereafter. The methods may further detect the person leaving the detection area.

Methods Differentiating Animate from Inanimate Objects

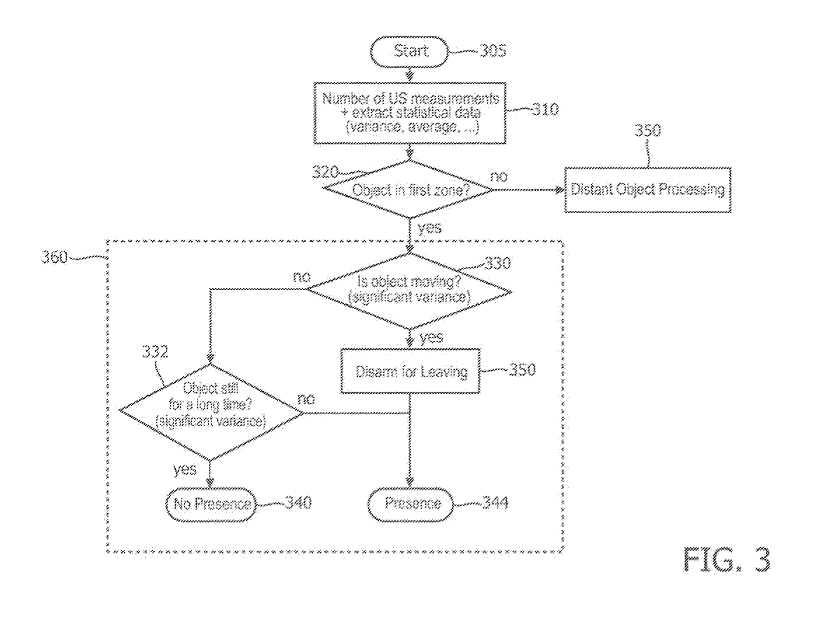

FIG. 3 is a flowchart of a first embodiment for a method for distinguishing animate objects from inanimate objects with a presence detector. The method under the first embodiment may be executed, for example, by a computer or an embedded microprocessor system. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

In general, the method under the first embodiment determines if an animate object is present within a detection area of a sensor. Inanimate objects within the detection area are distinguished from animate objects, so that the method does not indicate the presence of an inanimate object within the detection area. The method further distinguishes between an inanimate object within the detection area and an animate object in a dormant state. The method also characterizes an animated object as leaving the detection area or not leaving the detection area. Examples of an indication of the presence of an animate object may include, but are not limited to, switching the power to a power outlet, turning an indicator light on or off, or sending a message through a wired or wireless network.

The method under the first embodiment begins at block 305. An ultrasound sensor is configured to transmit a signal into a detection area and receive a reflection of the signal from an object within the detection area. A number of ultrasound measurements are taken, as shown by block 310. An example of an ultrasound measurement is an ultrasound sensor transmitting an ultrasound pulse and receiving the reflection of the ultrasound pulse. The time-of-flight between the transmitted pulse and the reflection may be measured. The time-of-flight may be used to calculate the distance between the ultrasound sensor and the object reflecting the pulse. Statistics are calculated using the current and previous ultrasound measurements. Examples of such statistics include, but are not limited to, the mean, the median, the mode, and the variance (block 310).

Reflections that are received by the ultrasound sensor after a threshold amount of time has elapsed after the ultrasound pulse has been transmitted may be ignored. This threshold time defines the outside distance boundary of the detection area. The detection area may further be divided into a first zone and a second zone, where the first zone includes an area within a first distance from the sensor, the second zone comprising an area beyond the first zone and within a second distance from the sensor, wherein the second distance is greater than the first distance. The second distance is generally the threshold distance 220 (FIG. 2).

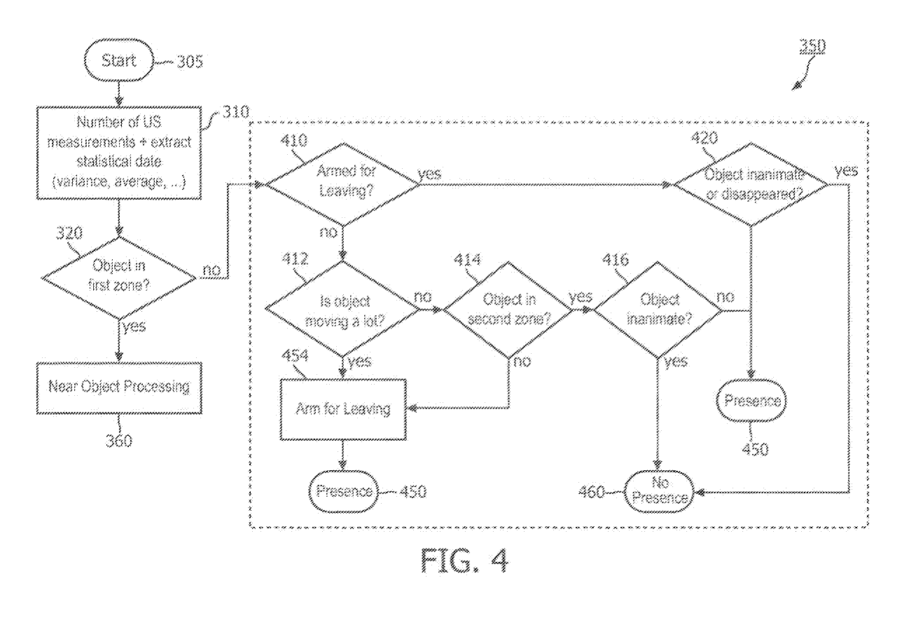

A determination is made whether an object is detected within the first one (block 320). Such a determination may be made, for example, by measuring the time-of-flight of a ultrasound pulse reflected back to the ultrasound sensor. If the ultrasound pulse reflection is detected within an amount of time signifying that the object is beyond the first zone, the method performs distant object processing (block 350). Distance object processing is discussed below in a detailed discussion of FIG. 4.

Still referring to FIG. 3, if the object is detected within the first zone, a determination is made whether the object is moving (block 330). This determination may be made, for example, by calculating the variance of the most recent time-of-flight value. It may be advantageous to use the variance to detect motion, as the variance, is defined as the squared difference from the mean. Squaring the difference makes it possible to detect even relatively small movements. Large movements may be distinguished from small movements, for example, by setting a variance threshold level, above which movements are considered large movements, and below which movements are considered small movements.

If a large movement is detected, the object it therefore both within the first zone and exhibiting significant movement, to the object it deemed not to be leaving the detection area (block 334), and furthermore considered to be present within the detection area (block 344). An example of how an object is deemed to be not leaving includes clearing a state variable, for instance, in a software state machine, where the setting the state variable indicates the object may be leaving the detection area, and clearing the state variable indicates the object may not be leaving the detection area.

If a large movement is not detected, the object is therefore within the first zone and not exhibiting significant movement. Therefore, it is determined whether the object has been still for a long time (block 332). The determination whether the detected object is inanimate, animate or dormant is made, as shown by block 332. For example, if an object shows little or no variance in time-of-flight measurement over a window of time, the object may be deemed inanimate, and no object is deemed to be present within the detection area (block 340). It should be noted that under the first embodiment, only the nearest detected object is considered within the method. However, there is no objection to alternative embodiments where the presence of two or more object may be detected, or embodiments where the threshold distance 220 (FIG. 2) is reset, for example, based upon the distance of the nearest detected inanimate object.

Referring to FIG. 4, a flowchart continues the method shown in FIG. 3, where block 350 is expanded for detailed description of the processing of distant objects. As described above, the blocks shown within block 350 are reached when an object is detected that is not in the first zone. If it has been previously determined that an object may be leaving the detection area (block 410), it is determined whether the object is inanimate or has disappeared (block 420). An object is deemed to have disappeared if it is not detected within the first zone or the second zone. As above, an object may be deemed inanimate if little or no variance in the time-of-flight measurement is detected over a time window. If the object is inanimate or has disappeared, the object is declared not present (block 450). If the object is not inanimate or has not disappeared, the object is declared present (block 450).

If an object has not been detected in the first zone and it has not been previously determined that an object may be leaving the detection area (block 410), the level of motion detected in the object is examined, as shown by block 412. If the object is moving significantly, for example, above a leaving threshold, the object is armed for leaving (block 454) and is declared present (block 450). Arming an object for leaving may be done by, for example, setting a Boolean flag indicating that subsequent processing should consider the object as potentially leaving the detection area.

If the object is not in the first zone, is not armed for leaving, and is not moving significantly, then the presence of the object within the second zone is checked, as shown by block 414. For example, an object may be determined to not be within the second zone if the measured time-of-flight indicates the distance between the object and the sensor is beyond the distance defining the end boundary 195 (FIG. 1B) of the second zone 190 (FIG. 1B). If the object is not in the second zone, the object is armed for leaving (block 454) and declared present (block 450). If the object is in the second zone, a determination is made whether the object is inanimate (block 416). As above, an object is considered inanimate if the time-of-flight variance remains below an animation threshold over a time window. If the object is inanimate, it is declared not present (block 460). Otherwise if the object is not inanimate, for example, an animate object in a dormant state, the object is declared present (block 450).

Under an alternative embodiment, an animated object may be characterized as leaving the detection area by detecting significant movement of the animated object in a direction away from the sensor. For example, the animated object may be characterized as leaving if the distance between the animated object and the sensor is increasing, and if the variance is above a leaving threshold. Similarly, the animated object may be characterized as leaving when the variance is above a leaving threshold and the distance between the animated object and the sensor is above a distance threshold. Characterizing an animated object as leaving may be also accomplished in other ways, for example, by dynamically adjusting the size of the first zone and/or the second zone based upon detected movement of the animated object.

### Presence Detecting System

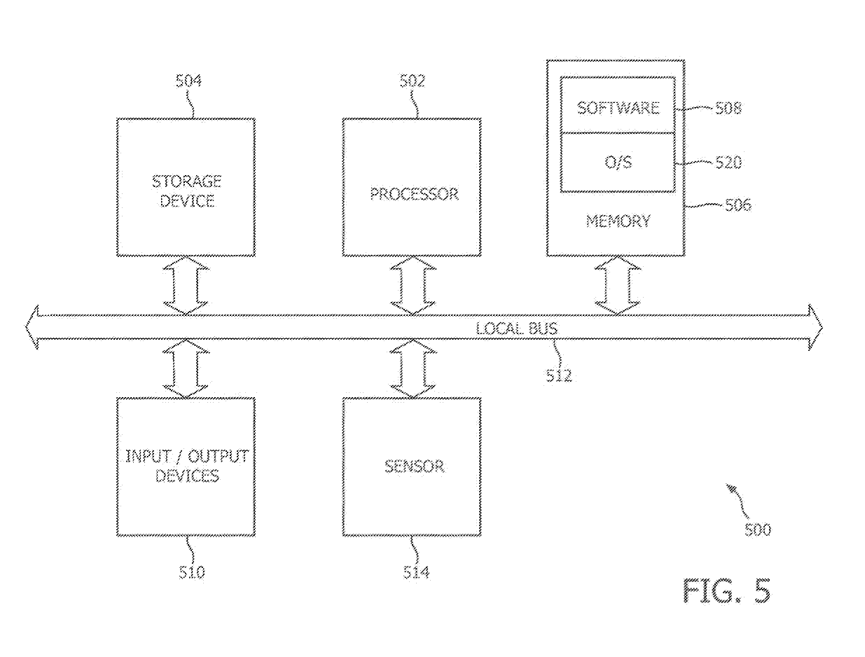

FIG. 5 is a schematic diagram illustrating an exemplary embodiment of a system for executing functionality of the present invention.

As previously mentioned, the present system for executing the functionality described in detail above may be an embedded microprocessor system, an example of which is shown in the schematic diagram of FIG. 5. The exemplary system 500 contains a processor 502, storage device 504, a memory 506 having software 508 stored therein that defines the abovementioned functionality, input and output (I/O) devices 510 (or peripherals), a sensor 514, and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

The sensor 514 may be, for example, an ultrasound presence sensor. The sensor 514 may be configured for one of several orientations, for example, a front sensor or a top sensor. The sensor 514 may convey sensing parameters, for example, time-of-flight data, to the processor 502 via the local interface 512. Similarly, the sensor 514 may receive configuration information and commands from the processor 502. For example, the processor 502 may send a command to the sensor 514 to collect a single set of measurements, or may send configuration information to the sensor configuring the sensor to collect sensing measurements at a regular interval.

When the system 500 is in operation, the processor 502 is configured to execute the software 508 stored within the memory 506, to communicate data to and from the memory 506, and to generally control operations of the system 500 pursuant to the software 508, as explained above. It should be noted that in other embodiments, one or more of the elements in the exemplary embodiment may not be present.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B” when used in conjunction with open-ended language such as “comprising” can refer, in one embodiment, to A only (optically including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited. Reference numerals appearing in the claims are provided merely for convenience and should not be viewed as limiting the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively as set forth in the United States Patent Office Manual of Patent Examining Procedures, Section 2111.03.

1. A method for detecting the presence of animate/inanimate objects with a sensor configured to transmit a signal and receive a signal reflection within a detection area comprising a first zone and a second zone, the first zone comprising an area within a first distance from the sensor, the second zone comprising an area beyond the first zone and within a second distance from the sensor, wherein the second distance is greater than the first distance, the method comprising the steps of:
detecting an object with the sensor;
determining if the object is in the first or second zone of the detection area;
if the object is within the detection area, characterizing the object as one of the group consisting of animate objects, and inanimate objects;
if the object is within the detection area and is characterized as inanimate, declaring the object not present;
if the object is within the detection area and is characterized as animate, declaring the object present; and
wherein the step of determining if the object is in the detection area includes measuring a time of flight variance between the signal transmission(s) and the signal reflection(s) and using a near object variance threshold when the object is in the first zone and a distant object variance threshold when the object is in the second zone.

2. (canceled)

3. (canceled)

4. The method of claim 1, wherein determining if the object is in the detection area further comprises the steps of:
calculating an object distance between the object and the sensor;
if the object distance is less than the first distance, determining the object is detected in the first zone; and
if the object distance is less than the second distance and greater than the first distance, determining the object is detected in the second zone.

5. The method of claim 4, further comprising the steps of:
if the object is not detected in the first zone, determining if the object is leaving the detection area by determining a level of motion of the object and using a leaving threshold value of movement.

6. The method of claim 5, wherein if the object, determining is not in the second zone, determining if the object is leaving the detection area by determining a level of motion of the object and using a leaving threshold value of movement.

7. The method of claim 6, wherein the step of determining if the object is leaving the detection area further comprises the step of:
if the object is not detected in the second zone, declaring the object not present.

8. The method of claim 2, wherein detecting whether the object is moving further comprises the steps of:
calculating an average time-of-flight; and
calculating a variance between the time-of flight and the average time of flight.

9. The method of claim 1, wherein the sensor comprises a front sensing ultrasound sensor.

10. The method of claim 1, wherein the sensor comprises a top sensing ultrasound sensor.

11. The method of claim 4, further comprising the steps of:
calculating an average time-of-flight;
calculating a variance between the time-of flight and the average time of flight;
adjusting the first distance and the second distance based at least partially upon the object distance and the variance.

12. (canceled)

13. (canceled)

14. (canceled)

15. (canceled)

16. (canceled)

17. A method, including a processor and an ultrasound sensor to detect the presence of animate/inanimate objects within a detection area comprising a first zone and a second zone, where the first zone comprises an area within a first distance from the sensor and the second zone comprises an area beyond the first zone and within a second distance (195) from the sensor, wherein the second distance is greater than the first distance, the method comprising the steps of:
transmitting a transmitted signal by the ultrasound sensor;
receiving a reflected signal, wherein the reflected signal comprises a portion of the transmitted signal reflected back from an object;
measuring a time-of-flight variance between the transmitted signal(s) and the reflected signal(s);
determining if the object is in the first or second zone of the detection area;
if the object is within the first zone of the detection area, characterizing the object as one of a group consisting of animate objects, and inanimate objects using a near object variance threshold;
if the object is within the second zone of the detection area, characterizing the object as one of the group consisting of animate objects, and inanimate objects using a distance object variance threshold;
if the object is within the detection area and is characterized as inanimate, declaring the object not present; and
if the object is within the detection area and is characterized as animate, declaring the object present.

18. (canceled)

19. The method of claim 17, wherein determining if the object is in the detection area further comprises the steps of:
calculating an object distance between the object and the sensor;
if the object distance is less than the first distance, determining the object is detected in the first zone; and
if the object distance is less than the second distance and greater than the first distance, determining the object is detected in the second zone.

20. The method of claim 19, further comprising the steps of:
if the object is not detected in the first zone, determining if the object is leaving the detection area by determining a level of motion of the object and using a leaving threshold value of movement.

21. The method of claim 20, wherein if the object is not in the second zone, determining if the object is leaving the detection area by determining a level of motion of the object and using a leaving threshold value of movement.
